(19) United States
(12) Patent Application Publication
(10) Pub. No.: US 2021/0084888 A1
(43) Pub. Date: Mar. 25, 2021

(54) Intelligent Control System for Deterring Problem Animals

(71) Applicants: Gregory William Lazar, Upton, MA (US); Owen Robert Mangan, Hopkinton, MA (US)

(72) Inventors: Gregory William Lazar, Upton, MA (US); Owen Robert Mangan, Hopkinton, MA (US)

(21) Appl. No.: 16/576,723

(22) Filed: Sep. 19, 2019

(51) Int. Cl. A01M 31/00; G06K 9/00; G06K 9/62; A01M 29/16; A01M 29/10; A01M 29/06

(52) U.S. Cl. CPC A01M 31/002; G06K 9/00362; A01M 29/06; A01M 29/16; A01M 29/10; G06K 9/628

(57) ABSTRACT

A self-contained, weatherproof control system containing logic that when connected to a video camera and loudspeaker, is a method for selective deterrence of problem individuals or populations of specific species of wildlife. Control system uses circuitry that interacts with video capture technology and extracts frames of video, then processed by object recognition software, powered by artificial intelligence and machine learning, which provides the ability to disregard any wildlife not considered nuisance and recognize and deter those animals that are considered a pest or a nuisance by way of a pre-configured action.

### BACKGROUND OF THE INVENTION

This invention relates to repelling animals and pests with integrated intelligence of deterring only specific, pre-determined pest animal(s) desired and ignoring all others. Unlike static solutions, this invention's intelligence can utilize many different, non-toxic, non-lethal methods to repel even the most stubborn animal.

Each year, millions of pest animals invade public and private areas causing countless dollars in lost revenue. These include livestock targeted by coyotes, wolves and bear, geese invading our parks depositing unsightly fecal matter on golf courses and beeches increasing coliform levels in our waterways, to even the more benign pests such as squirrels and other small rodents. Unfortunately with the increase in population of these pests the problem will continue to get worse.

### SUMMARY OF THE INVENTION

As will become clear from the following description, this control system in accordance with the present invention comprises a small, weatherproof case with a solar powered control unit. When the pre-determined pest animal is recognized by the intelligent control circuitry, user selected alerts or alarms will sound, which will cause the pest animal to sense danger. Occurring in random combinations of amplitude, frequency and duration, these audio alerts will be appreciated as either indicating an uneasiness of potential danger or signifying immediate danger. With the control system's interface, a mechanical actuator activating realistic visual decoys such as predatory animals may be used to supplement the control system.

The weatherproof device (labeled as #103 in the figures) is preprogrammed to recognize a multitude of known pest animals. During initial setup, the user selects the pest animal(s) to be deterred from the internal database catalog, then the recommended deterrent audible sounds, along with optional audio or visual alerts. Using embedded visual recognition and artificial intelligence software, the control system will monitor a select area continuously. When a pest animal is recognized, the audio, visual or mechanical deterrent is triggered. Subsequent triggers can be audio or visual alerts that vary in type, amplitude and volume.

As will also be understood, the intelligent software embedded in the control unit will recognize selected pest animals, such as migratory Canadian geese, while ignoring welcomed songbirds, even animals as similar as a mallard.

As will also be understood, pest animals, by nature, are persistent, and this solution, being equipped with solar panel and an option of continuous power will provide round-the clock uninterrupted deterrence to territorial and stubborn animal types.

As will also be understood, by recognizing the specific animal targeted, the control system can be utilized to target small pests such as poisonous snakes to larger predatory animals including wolfs, coyotes and bear.

As will also be understood, the control system will discourage the selected pest or pests by activating the appropriate sound or visual alert, and alternating the alerts with a virtually limitless catalog of sounds including human sounds, to the appropriate predatory sound, to gunshot and other explosive audio.

In certain embodiments, a method of deterring selected pest animals in a designated area includes implementing at least one configuration of the control system. The method further includes (i) obtaining at least one stream of video input that encompasses the designated area, (ii) having obtained the video input, processing each frame of the video input to determine if a selected pest animal is recognized by the model, along with the degree of certainty and, (iii) taking an appropriate/configured action if the object identified meets the configured criteria for a selected pest animal.

In certain aspects, the control system, after being provided with a neural network or model that has been trained to recognize specific pest animals, along with the number of pest animals, preferred size of the video input frames and threshold for the degree of certainty to use for each pest animal, processes individual frames of video input, and relies on the neural network or model, trained to recognize specific pest animals by processing the video frames provided. The method further includes (i) the model having determined the type of pest animal(s) captured within the video frame, and a degree of certainty with regard to those types, tagging these pest animals and returning this information to the image processor (ii), the image processor forwards that information to the action rules engine, and (iii) processing each pest type and degree of certainty, attempting to match rules configured in the rules engine database, which dictate which pest animals are considered a nuisance, and the appropriate action to take when those pest animals are detected.

Techniques are disclosed herein for recognizing and discouraging selected pest animals in a designated area. The disclosed techniques allow for specific pests to be identified and deterred from encroaching on a designated area. The disclosed techniques can perform automatic identification of the pests and can take subsequent action based on how the device is configured to react.

By allowing the user to make changes to the configured actions, in response to a specific pest, they can, via trial and error, ascertain what the best response is for the given pest animal.

### BRIEF DESCRIPTION OF THE DRAWINGS

The foregoing and other objects, features and advantages will be apparent from the following description of particular embodiments of the invention, as illustrated in the accompanying drawings, in which like reference characters refer to the same parts used throughout the different views.

FIG. 1 is a block diagram of an outdoor environment, in which exemplary techniques for detecting nuisance animals, and taking appropriate actions, can be employed;

FIG. 2 is a block diagram of an exemplary control system, with speaker and video camera, in the outdoor environment.

FIG. 3 is a flow diagram of an exemplary method of accepting video input, detecting nuisance animals and taking an appropriate action, scaring the nuisance animal from the selected area.

### DETAILED DESCRIPTION

Techniques are disclosed herein for thwarting nuisance animals in a specified outdoor environment. The disclosed techniques allow an individual, with the intent of protecting an area that is subject to the encroachment of undesired nuisance animals to configure the nuisance animal detector such that when a particular animal is detected, it will take the appropriate action. These actions may include audible such as triggering a loud noise or predatory sound, visual alerts such as a flashing light, or mechanically actuated movement simulating a threat to the nuisance animal. These types of deterrents may be used independently, simultaneously or randomly.

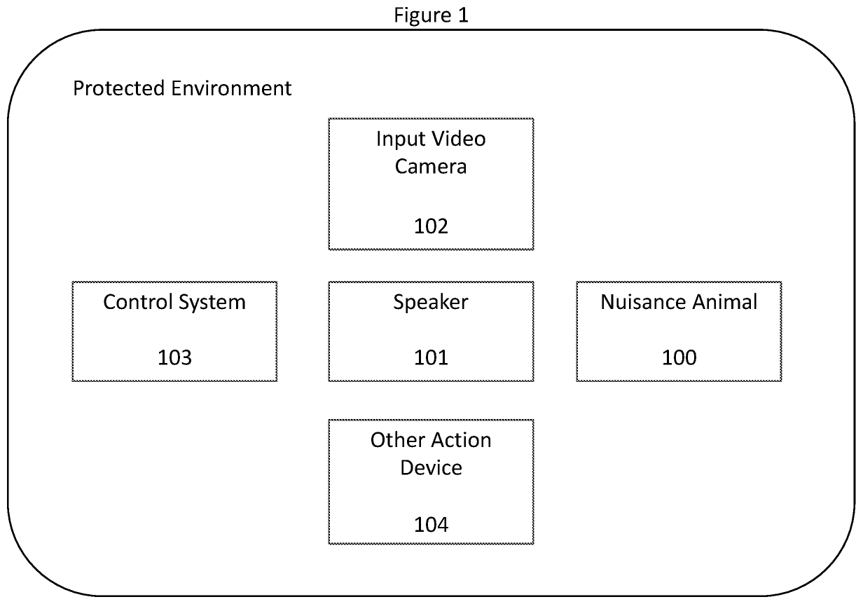

FIG. 1 depicts an illustrative embodiment of a specified, protected environment 100, in which exemplary techniques for thwarting nuisance animals can be employed. As shown in FIG. 1, the protected environment can include one or more control systems 103, that encompass a video camera 102 for video input, an attached speaker 101 for sound output, and other action devices 104, such as a strobe light, or a mechanical actuator.

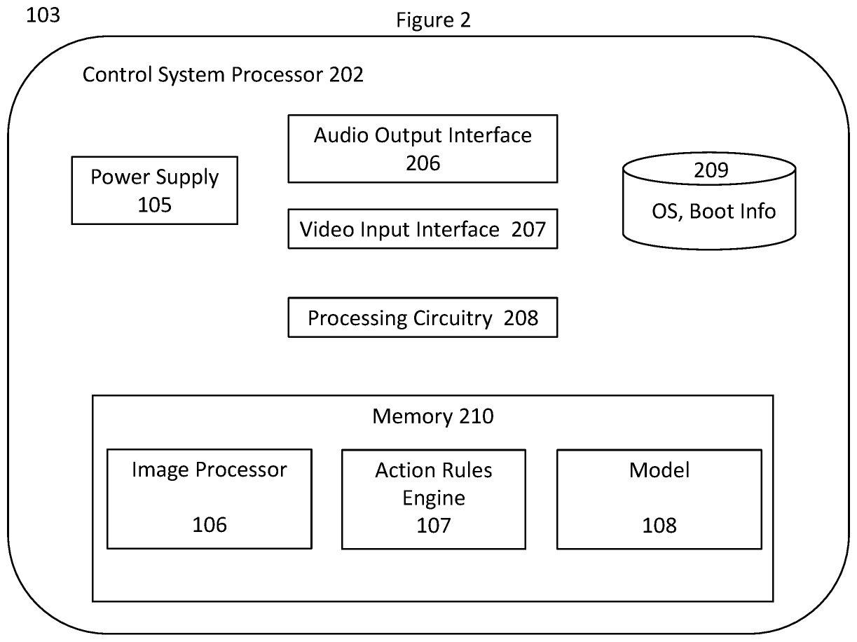

FIG. 2 As shown in FIG. 2., the control system can include one or more communication interfaces such as sound output 206 and video interfaces 207, specialized processing circuitry 208, and a local memory 210, as well as a local drive 209 that stores an operating system (OS) image, boot information, etc.

The local memory 210 of the control system can (see FIG. 2) be configured to include (e.g. dynamic random access memory nuisance (DRAM), static random access memory (SRAM)), as well as non-volatile storage (e.g., magnetic memory, flash memory). As shown in FIG. 2, the local memory 210 can be configured to store a verity of software constructs, including an image processor 101, a model 108 which is the training data used by the image processor 101 to detect nuisance animals, and an action engine 102, that will be configured to decide the appropriate action to be taken, given the output data from the image processor.

The various software constructs stored in the local memory 210 of the control system processor 202 (see FIG. 2) can include one or more sets of instructions that direct the specialized processing circuitry 208 to implement the techniques described herein. For example, the control circuitry 208 may be implemented in various ways, using one or more processors (or cores) running specialized software, one or more application specific integrated circuits (ASIC), and one or more field programmable gate arrays (FPGAs), as one or more discrete components, digital circuits, analog circuits, and so on, or any suitable combination thereof. In the context of the processing circuitry 208 being implemented using one or more processors running specialized software, a computer program product can be configured to deliver all or a portion(s) of the various software constructs to the processing circuitry 208. Such a computer program product can include one or more non-transient computer-readable storage media, such as magnetic disk, a magnetic tape, a compact disk (CD), a digital versatile disk (DVD), an optical disk, a flash drive, a solid state drive (SSD), a secure digital (SD) chip or device, an application specific circuit (ASIC), a field programmable gate array (FPGA), and so on. The non-transient computer-readable storage media can be encoded with sets of instructions that, when executed by one or more of the processors, perform the techniques described herein. Such media may be considered to be articles of the manufacture, and may be transportable from one nuisance animal detector to another nuisance animal detector.

The techniques described herein for deterring nuisance animals (see FIG. 1) will be further understood with reference to the following illustrative example. In this example, the control system 103 is initialized with a Model 108 that has been trained to recognize specific pest animals. Additionally, it's provided with an associated config file indicating, amongst other things, the number of pest animals that the Model 108 has been trained for, along with associated names for each pest animal. The control system 103 is also provided with the spatial size, width and height in pixels, that the neural network expects for the video frames, and a threshold for the confidence level returned by the neural network (Model 108), used to indicate whether or not a pest animal has actually been found. The Images Processor 106 in the Control system 103 leverages the Video Input Interfaces 207 to receive video input from Input Video Camera 102. It subsequently separates the supplied video input into individual frames, each of which is then provided to the Model 108, along with the spatial size. The Model 108, previously trained using machine learning techniques, processes the individual frame and identifies, with a degree of certainty, various objects it's been trained to recognize, within the frame. This information is then returned to the Image Processor 106. The Image Process 106 then provides this information to the Action Rules Engine 107. The Action Rules Engine 107, based on what nuisance animals 100 it's been configured to take action on, processes each object that has been identified, and the degree of certainty to which the model provided for the identification. If the object type is one that the Action Rules Engine has been configured to act on, and the degree of certainty is within the configured threshold (percentage), the Action Rules Engine 107 will look at the configured action for that object type, and invoke it. In this example the Sound Output Interfaces 206 are leveraged to output a sound designed to scare the Nuisance Animal 100 that's been identified by the Model 108.

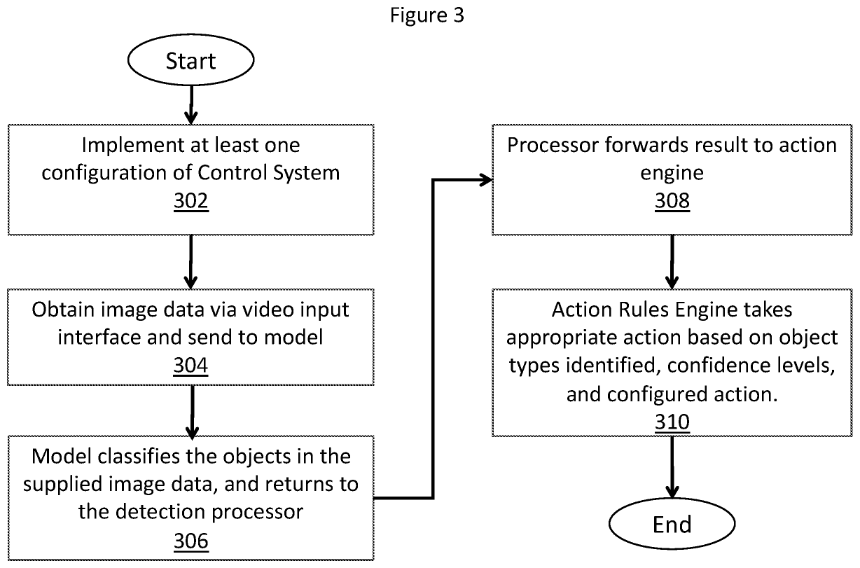

An exemplary method of deterring nuisance animals in a designated area is described below with reference to FIG. 3. As depicted in block 302, at least one configuration of the nuisance animal detector is implemented in order to protect a designated area. As depicted in block 304, video input is obtained by the control system. As depicted in block 306, having obtained the video input, individual video frames are provided to the model which classifies known objects within the frame. As depicted in block 308, the image processor then forwards this information to the action rules engine. As depicted in block 310, the action rules engine checks its configuration, and the objects identified, along with the degrees of certainty that the objects are what has been identified. If one or more of the objects meets the configured criteria, the action rules engine will execute the configured action for that object.

Having described the illustrative embodiments, other modifications and/or variations may be made and/or practiced. For example, it was described herein that

In some embodiments, the power supply 105 may be a battery, such as a NiCad or Li-ion battery. in other embodiments, the power supply may be an AC supply, such as a house main current. In still other embodiments, the power supply may be a solar cell.

In some embodiments, deterrent could be visual such as a strobe light or laser. In other embodiments the deterrent could be a mechanical movement of a servo to cause other effects.

In other embodiments the speaker 206 may be an external loudspeaker or loudspeakers.

In other embodiments the device may be deployed atop a drone for aerial surveillance.

While various embodiments of the invention have been particularly shown and described, it will be understood by those skilled in the art that various changes in form and details may be made therein without departing from the scope of the invention as defined by the appended claims.

1. A method of deterring a pest animal from an area, the method comprising:
receiving, by processing circuitry, video input which captures a set of images of the pest animal;
selecting, by the processing circuitry embedded in the control system, a particular pest animal classification from a plurality of pest animal classifications based on the video input, the particular pest animal classification identifying a particular animal type among multiple animal types; and
in response to selecting the particular pest animal classification, performing a set of pest deterrent operations to deter the pest animal from the area.

2. The method of claim 1 wherein selecting the particular pest animal classification includes:
performing a set of artificial intelligence operations to select the particular pest animal classification among the plurality of pest animal classifications; and
processing each pest type and degree of certainty by matching rules configured in the control system's rules engine database, which dictate the appropriate action to take when a certain pest animal is detected

3. Electronic apparatus, comprising:
a communications interface to:
update pest animal models download reports to PDF, Excel or other common reporting tool connect to an external loudspeaker, light and mechanical actuator; and
memory which stores a local application; and
control circuitry coupled to the communications interface and the memory; the memory storing instructions that, when carried out by the control system, will cause the device to:
receive, through the communications interface, video input which captures a set of images of the pest animal,
select a particular pest animal classification from a plurality of pest animal classifications based on the video input, the particular pest animal classification identifying a particular animal type among multiple animal types, and
in response to selecting the particular pest animal classification, perform a set of pest deterrent operations to deter the pest animal from an area;

4. The electronic apparatus of claim 3 said apparatus further comprising at least one power source having reusable solar technology for powering control circuitry;
